(19) United States
(12) Patent Application Publication
(10) Pub. No.: US 2009/0199470 A1
(43) Pub. Date: Aug. 13, 2009

(54) Device and Method for Observing Plant Health

(76) Inventors: Larry Capen, Reno, NV (US); William Anderson, Fallbrook, CA (US)

Correspondence Address: IAN F. BURNS & ASSOCIATES, 4790 Caughlin Parkway #701, RENO, NV, 89519-0907, US

(21) Appl. No.: 12/424,776

(22) Filed: Apr. 16, 2009

Related U.S. Application Data
(63) Continuation-in-part of application No. 11/189,244, filed on Jul. 25, 2005, now abandoned.
Application No. 11/189,244 is a continuation-in-part of application No. 10/437,159, filed on May 13, 2003, now Pat. No. 6,921,182.

(51) Int. Cl. A01G 7/00

(52) U.S. Cl. 47/58.1 LS

(57) ABSTRACT

A lamp for growing plants includes a first set of orange light emitting diodes that have a peak wavelength emission of about 612 nanometers, a second set of red light emitting diodes that have a peak wavelength emission of about 660 nanometers and a third set of blue light emitting diodes that have a peak wavelength emission of about 465 nanometers. The lamp also includes a green light emitting diode that has a wavelength emission that is between 500 and 600 nanometers. The green light emitting diode provides a human observer with an indication of general plant health.

### CROSS REFERENCE TO RELATED APPLICATIONS

This application is a continuation-in-part of U.S. patent application Ser. No. 11/189,244 filed Jul. 25, 2005 which is a continuation-in-part of U.S. patent application Ser. No. 10/437,159, filed May 13, 2003, now U.S. patent publication number 2004/0230102. These applications are hereby expressly incorporated by reference in their entirety.

### FIELD OF THE INVENTION

The present invention relates to growing plants.

### BACKGROUND

For decades scientists have delved ever deeper into the inner workings of plants, and particularly into those processes that are driven by the chemical capture of light energy. At the same time, research into new methods for converting electricity into light of particular wavelengths has led some engineers to try to produce artificial lighting which promotes plant growth. Until recently this has meant modifying energy inefficient “white light” sources to produce more light at wavelengths known to promote plant growth and health. This hybrid technology, in which the bulk of the light from these augmented “plant grow lights” can't be used efficiently by plants, has dominated the market for four decades.

While electricity was abundant and cheap, these “old school” plant grow lights, based mainly on HID, high pressure sodium, or fluorescent style lamps, were acceptable despite their imperfections. But they still have many shortcomings. They typically convert only 10-15% of electrical energy into light, and only a very small portion of that light can be used by plants. Some of them, particularly the HID lamps, emit short wavelength UV light which is damaging to both the plants being grown under them and the people tending the plants. All of these lamps generate waste heat which must be eliminated to prevent damage to the plants they illuminate, adding to their operational cost. They contain environmentally damaging metals, are fragile, and have a short operating life.

As electricity supplies fail to keep pace with demand, leading to ever higher prices, the need for more efficient plant growing lights increases. The latest generation of high output LEDs, with their narrow light output wavelengths, are a good choice for creating the next generation of plant grow lighting. Most LED plant grow lighting systems available today can only be used in a laboratory. The others, while claiming to be useful to commercial plant growers, are merely modifications of the laboratory-specific systems.

No one has yet developed an efficient LED-based plant growing light that is amenable to both home lighting design and commercial plant production. By utilizing an LED lamp as a bulb, which can be used in industry standard lighting fixtures, the present invention provides a product that has universal appeal and marketability. The present invention further provides a lamp that can be manufactured inexpensively with readily available parts for both home and commercial use.

The preferred power source is the subject of utility patent application Ser. No. 10/397,763 filed Mar. 26, 2003 and entitled USE OF TRACK LIGHTING SWITCHING POWER SUPPLIES TO EFFICIENTLY DRIVE LED ARRAYS.

A key part of the research of the present invention involved the determination of which light frequencies or wavelengths would produce superior plant growth results. Each plant pigment absorbs light at one or more specific wavelengths. The areas of peak absorption for each pigment are narrow, and the measurements made with pigments concentrated in a test tube are different than those done on living plants. The wavelength of the light used determines it's energy level, with shorter wavelengths having greater energy than longer wavelengths. Thus each absorption peak, measured by the wavelength of light at which it occurs, represents an energy threshold that must be overcome in order for the process to function.

There are many peaks of light absorption in the pigments found in plants, and ideally it would be best to match them each with the most appropriate LED. But this is not practicable because of the limited desired area available in the lamp being designed, and because LEDs are not available in every wavelength of the spectrum. The compromise is to see what LEDs are readily available and match them, as well as one is able, to groups of closely matched pigment absorption peaks, while striving to meet the minimum requirements of plants for healthy growth.

A patent search turned up U.S. Pat. Nos. 5,278,432 and 5,012,609, both issued to Ignatius et al., who suggest LED plant radiation very broadly within bands 620-680 or 700-760 nm (red) and 400-500 nm (blue). After a year and a half of research, three specific light wavelengths that produced the best plant growth results were discovered.

660 nanometers (nm) is the wavelength that drives the engine of the photosynthetic process. The 680 nm wavelength is perhaps closer to the peak absorption wavelength of one of the two chlorophylls found in higher plants. However, at 680 nm the absorption curve of the second chlorophyll is missed, and furthermore the output curve of a 680 nm LED has a fair amount of light output above 700 nm, which is known to cause unwanted morphological changes to plants. LEDs of 680 nm output are also rare in the marketplace, making them relatively expensive. The choice of a 660 nm first wavelength component is a compromise wavelength commonly used in plant growing research, which supplies energy to both types of chlorophyll without emitting enough light above 700 nm to adversely affect plant growth.

The 620 nm LEDs used in the aforesaid Ignatius et al. patents, are meant to provide the light energy for photosynthesis, but a look at the absorption spectrum for the two chlorophylls shows that this wavelength falls almost entirely outside the absorption curve for chlorophyll.

The research of the present invention showed better results using LEDs of 660 nm and 612 nm rather than the wavelengths of 620 nm and 680 nm. Beneficially, LEDs of 660 nm are also readily available in the market, and are very inexpensive.

A second 612 nm wavelength component was selected not to promote photosynthesis, but to match one of the peaks of the carotenoids. As noted in “Influence of UV-B irradiation on the carotenoid content of Vitis vinifera tissues,” C. C. Steel and M. Keller (http://bst.portlandpress.com/bst/028/0883/bst028883.htm), “carotenoid synthesis . . . is dependent upon the wavelength of visible light, and is diminished under yellow and red filters.”

By providing the orange 612 nm light, we not only promote creation of carotenoids, which are required for plant health, but also add a little to photosynthesis, since the carotenoids pass their absorbed energy to chlorophyll. Carotenoids are required for plant health due to their ability to absorb destructive free radicals, both from solar damage and from chlorophyll production, whose precursors will damage plant tissue in the absence of the carotenoids. During research it was found that, beneficially, test plants turned a deeper green, i.e. produced more chlorophyll, with the addition of our 612 nm light component. This ability to increase a plant's chlorophyll content with this specific light wavelength is an important aspect of our invention.

Blue light of about 465 nm, this wavelength being non-critical, is strongly absorbed by most of the plant pigments, but is preferably included as the third component in the present invention lamp to support proper photomorphogenesis, or plant development. Any LED near this wavelength will work as well, but the 470 nm LEDs are commonly available and less expensive than many other blue LEDs.

Regarding the proper proportion for each wavelength, it is known, from independent laboratory research, that a blue/red proportion of 6-8% blue to red is optimal. In sunlight the blue/red light proportion is about 30%, but this is not required by plants. More than 8% blue light provides no additional benefit, but adds to the cost of the device since blue LEDs are among the most expensive to manufacture. In our device we include about 8% blue light, which is near optimal for plant development while offering the greatest cost savings. Research showed that best results were obtained when the output of the 612 nm orange LEDs in the present invention device was added to the output of the 660 nm red LEDs when calculating the most desired blue/red proportion.

The lamp of our invention is intended to deliver a well mixed blend of all three of the wavelengths used to the plant it is illuminating. Other devices which are intended to grow plants with LEDs solve this problem by creating alternating rows of each wavelength of LED used, with each LED string being composed of LEDs of the same wavelength. In these other devices, though, the LEDs are arranged in a square or rectangular block, matching the shape of the device itself. In our case, with a circular design, this is not the most effective way to align the LEDs.

To improve the manufacturability of the circular lamp of the present invention, it proved better to use LED strings that mixed wavelength, i.e. instead of putting the 660 nm LEDs into their own strings, strings that contain both 660 nm and 612 nm LEDs, and in one string use all three wavelengths. Normally this isn't done because it offers a greater potential for having a “current hogging” LED alter the string's designed operating characteristics. Current hogs can be a problem even when all of the LEDs in a string are of the same wavelength and manufacture, but when the string is composed of a mixture of wavelengths the chances of having this problem are increased. LED strings of mixed wavelength are to be used when the supplied voltage and current is tightly controlled.

Regarding prior art found during the patent search, the mounting and plug in of an LED array light module in a MR-16 or the like fixture is disclosed in Lys U.S. Pat. No. 6,340,868 in FIGS. 20 and 21. Lys teaches the use of these LED array modules for accelerating plant growth; see FIGS. 92A and 92B. Lys also teaches in FIG. 22 the use of a 24 volt DC module for energizing three LED strings connected in parallel. Lowrey U.S. Pat. No. 6,504,301 discloses an MR-16 outline package for a mixed wavelength LED arrangement; other lighting packages such as MRC-11 etc. are mentioned in his specification col. 7. Okuno U.S. Pat. No. 4,298,869 discloses a conventional lamp screw in fixture for three parallel LED strings of two volt LEDs supplied by 19.5 volts. The concept of placing the LEDs very close to the plants as they generate little heat is taught in col. 1 of U.S. Pat. No. 6,474,838.

### BRIEF SUMMARY OF ONE EMBODIMENT OF THE INVENTION

### Advantages of One or More Embodiments of the Present Invention

The various embodiments of the present invention may, but do not necessarily, achieve one or more of the following advantages:

the ability to observe general plant health of plants grown under light emitting diode lights;

provide a plant growing lamp that outputs light frequencies that are optimized for use by plants;

provide a plant growing lamp that has a combination of beam spread angles that provide good light penetration into a leaf canopy;

provide a plant growing lamp that outputs red, orange, blue and green light;

provide a plant growing lamp that outputs green light;

provide a plant growing lamp that enhances the appearance of plants grown under the lamp;

provide a plant growing lamp that allows a human observer to determine the general health of the plants;

provide a plant growing lamp that has beam spread angles between eight and forty-five degrees.

These and other advantages may be realized by reference to the remaining portions of the specification, claims, and abstract.

### BRIEF DESCRIPTION OF ONE EMBODIMENT OF THE PRESENT INVENTION

It is a feature of the invention to provide a lamp for plants that includes a first set of orange light emitting diodes that have a peak wavelength emission of about 612 nanometers, a second set of red light emitting diodes that have a peak wavelength emission of about 660 nanometers and a third set of blue light emitting diodes that have a peak wavelength emission of about 465 nanometers. The lamp also includes a green light emitting diode that has a peak wavelength that is between 500 and 600 nanometers. The green light emitting diode provides a human observer with an indication of general plant health.

Another feature of the invention is to provide a method of determining plant health that includes providing a light emitting diode lamp that emits green light that has a wavelength between 500 and 600 nanometers. A plant is illuminated with incident light generated by the lamp. The light reflected from the plant is viewed by an observer to give an indication of plant health.

Additional features of certain embodiments of the invention will further be described below. It is to be understood that the invention is not limited in its application to the details of the construction and to the arrangement of the components set forth in the following description or as illustrated in the drawings. The invention is capable of other embodiments and of being practiced and carried out in various ways. Finally, it is understood that the scope of the present invention is to be determined by reference to the issued claims and not by whether a given embodiment meets every aspect of this brief summary or satisfies every deficiency or problem with the prior art as noted above.

### BRIEF DESCRIPTION OF THE DRAWINGS

Certain embodiments of the invention are shown in the following drawings where:

FIG. 1 discloses four strings of diodes coupled to the power supply;

FIG. 2 discloses the diodes of FIG. 1 positioned within a circular lamp;

FIG. 2a discloses a table for use in understanding FIG. 2;

FIG. 3 discloses a graph showing a curve of the wavelength spectrum of the lamp output of our invention in its preferred embodiment;

FIG. 4 illustrates the mixed beam spread feature of the invention;

FIGS. 5a and 5b, 6, and 7a and 7b, show various aspects of controlling growth rates employed in connection with the invention.

FIG. 8 is substantially a front view of a lamp for growing plants that can give a human observer a visual indication of general plant health in accordance with the present invention.

FIG. 8a discloses a table for use in understanding FIG. 8.

FIG. 9 is substantially a perspective view of a human observer using the lamp of FIG. 8.

FIG. 10 is substantially a front view of another embodiment of a lamp for growing plants that can give a human observer a visual indication of general plant health.

FIG. 10a discloses a table for use in understanding FIG. 10.

FIG. 11 is substantially a front view of another embodiment of a lamp for growing plants that can give a human observer a visual indication of general plant health.

FIG. 11a discloses a table for use in understanding FIG. 11.

FIG. 12 is substantially a front view of yet a further embodiment of a lamp for growing plants that can give a human observer a visual indication of general plant health.

FIG. 12a discloses a table for use in understanding FIG. 12.

FIG. 13 is substantially a front view of another embodiment of a lamp for growing plants that incorporates alternative beam spread angles.

FIG. 13a discloses a table for use in understanding FIG. 13.

FIG. 14 is substantially a front view of an alternative embodiment of a lamp for growing plants that incorporates different beam spread angles.

FIG. 14a discloses a table for use in understanding FIG. 14.

### DESCRIPTION OF THE EMBODIMENTS

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Five light wavelengths commonly known to match the absorption peaks of plant pigments were identified: 430 nm (blue, near ultraviolet), 450 nm-470 nm (blue), 570 nm (lime green), 610 nm (orange), and 660 nm (red). The experimental efforts in turning theory into practice to select the best components, was anything but straightforward, and has taken the better part of a year to bring to its current level of development. The final test results have allowed the elimination of the 570 nm lime green LED. This left the following mix in one embodiment:

12.times.660 nm (Red), 30 degree beam angle spread;

12.times.660 nm (Red), 15 degree beam angle spread;

6.times.612 nm (Orange), 30 degree beam angle spread;

6.times.612 nm (Orange), 15 degree beam angle spread; and

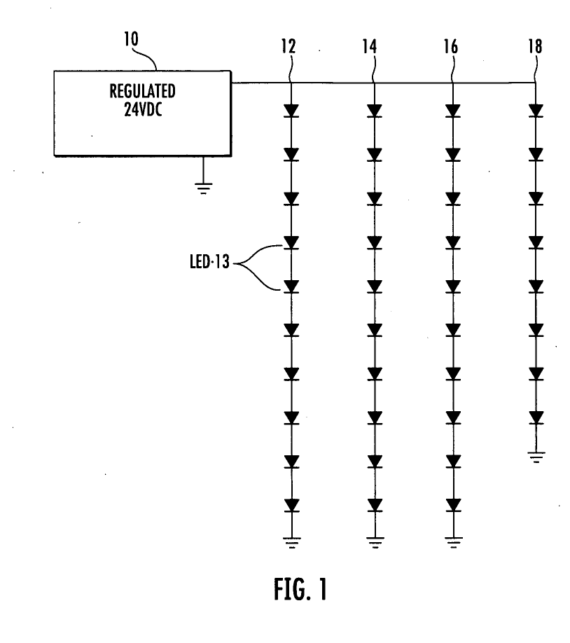

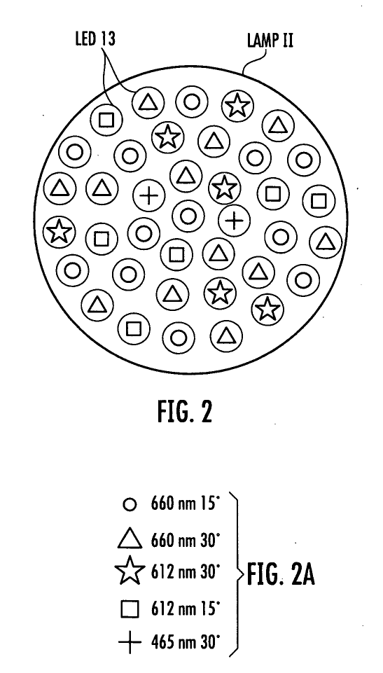

2.times.465 nm (Blue), 30 degree beam angle spread; all as shown in FIGS. 1, 2, and 2A.

It was determined that the superior results were not caused by the 570 nm green LEDs, and the results were substantially improved using the wavelength mix shown above. The number of variables being tested made it difficult to isolate the exact effects caused by the different light wavelengths used, and it has only just become apparent that the 570 nm light wavelength was superfluous.

Research into plant growth using this final light frequency mix showed it gave superior results over the earlier research. The plants grown, particularly cotton and miniature roses, became dark green (i.e. generated large amounts of chlorophyll), had broad rather than narrow leaves, maintained healthy leaves in the under story of the leaf canopy, and had short leaf internodes, while growing vigorously.

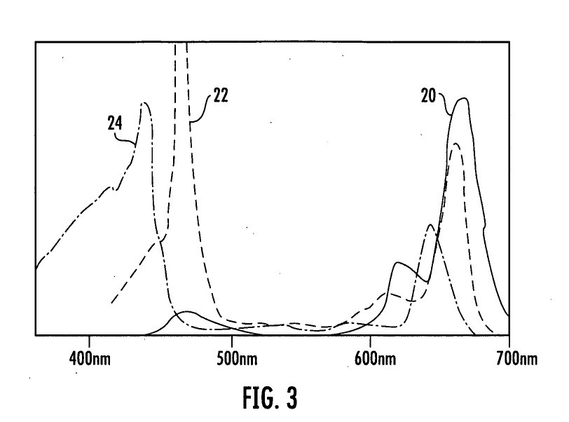

The graph of FIG. 3 shows a solid line curve 20 of the wavelength distribution output of the present invention in one embodiment compared to the absorption spectrum curve 24 of chlorophyll A and absorption curve 22 of chlorophyll B 22, the wavelengths which most efficiently drive photosynthesis range between 600 nm and 700 nm, which closely matches the output peaks of the present invention. Even though chlorophyll has its strongest absorption in the blue wavelengths, these wavelengths are very inefficient for driving the photosynthetic processes. The small amount of blue in the present invention, is not used to drive the photosynthetic process, but is instead used to promote proper plant morphology. Thus, the final LED wavelength mix covers the absorption peaks for both chlorophyll A and chlorophyll B. The 465-470 nm LEDs also supply energy to the two chlorophylls, as well as the carotenoids, but inefficiently. The main purpose of the 465 nm light is to support photomorphology, promoting a short, compact growth pattern, broad leaves, and thick stems. The amount of blue light (460 nm to 470 nm) provided is optimally 6% to 8% of the provided amount of orange/red light within the 600 nm to 700 nm range. Sunlight is approximately 30% light in the blue portion of the spectrum, but it has been shown by university researchers that amounts higher than 8% provide no additional benefit.

As shown in FIG. 1, a circular lamp embodiment contains thirty-eight LEDs, as follows: 12 narrow beam angle red LEDs labeled r, 12 wide beam angle red LEDs labeled r-, 6 narrow beam orange LEDs labeled o, 6 wide beam orange LEDs labeled o-, and 2 wide beam blue LEDs labeled b.

The circuit of FIG. 1 for driving the LEDs includes regulated 24 volt DC power source 10 that supplies three strings of LEDs, 12, 14, and 16, and one string of eight LEDs 18. Each string contains a mix of the LED wavelengths and beam spreads used in the invention, denoted ‘r’ for 15 degree beam spread 660 nm (narrow beam red), ‘r-’ for 30 degree beam spread 660 nm (wide beam red), ‘o’ for 15 degree beam spread 612 nm (narrow beam orange), ‘o-’ for 30 degree beam spread 612 nm (wide beam orange), and ‘b’ for 30 degree beam spread 465 nm (wide beam blue).

FIG. 2 schematically indicates a typical spatial distribution of the LEDs 13 of FIG. 1, as viewed looking into circular lamp 11 containing the LEDs. FIG. 2, along with the table of FIG. 2a, indicates the peak wavelengths and beam angles of light emission from the various LEDs in a typical arrangement for providing good mixing.

LEDs are manufactured to emit light with a particular viewing angle, or beam spread. Typically the narrower the beam spread the higher the light pressure or intensity produced, and vice versa. If the beam spread is too narrow, the light from adjacent LEDs may not overlap, leaving gaps in the illumination area. For a plant growing light this would not be appropriate. Conversely, if the beam spread is too wide, the illumination area will be too large, covering areas beyond the plant's leaf canopy, so a great deal of light will be wasted. LEDs were selected which would, in an embodiment for general use, provide a circle of illumination approximately 10-12 inches wide at a distance of ten inches from the light source. Since one of the embodiments is smaller than 3″ in diameter, 100% illumination coverage of many size areas for commercial use and in the home is possible.

Growers employing artificial light sources for growing plants are cautioned to use fluorescent lighting only for seedlings, and to switch to High Intensity Discharge or High Pressure Sodium lamps after the plants are 12″ to 18″ tall. Fluorescent lighting is preferred because of its lower energy cost, but it has such a low light output that none of the light striking the upper leaf canopy can penetrate to the lower leaves, causing spindly growth. HID and HPS lights produce adequate light to penetrate a number of layers of leaf canopy, but at a much higher energy cost. The high temperature of HID and HPS lighting (the quartz envelope of the bulb exceeds temperatures of 1500 degrees F.) is also more dangerous for the immature stems and leaves of seedlings.

Unlike conventional light bulbs, LEDs are manufactured to produce a directed beam of light, with a viewing angle, or beam spread, ranging from as little as 5 degrees to over 120 degrees. The present invention takes advantage of this characteristic of LEDs to produce a plant growing light source which combines low power consumption with the ability to penetrate the upper leaf canopy and provide adequate light to lower leaf levels.

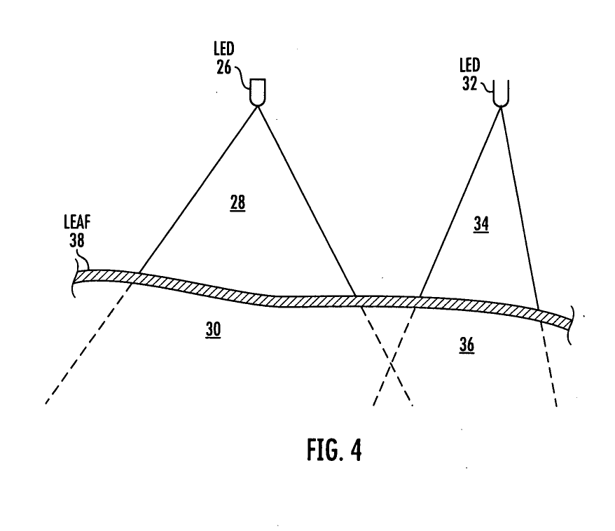

As shown in FIG. 4, a wide beam LED 26 directs its light beam 28 onto the upper surface of a leaf 38. Measurements made at a point below the leaf 30 show only 10% of the light passes through the leaf to be available to the leaves below. A narrow beam LED 32 directs its light beam 34 onto the upper surface of leaf 38. In this case, measurements made at a point below the leaf at 36 show 80% of the light passes through the leaf to be available to the leaves below. When used in a 1:1 mix of wide to narrow beam LEDs, approximately 50% of the supplied light is available to the lower levels of the plant canopy. More specifically, two beam spreads, 15 degrees and 30 degrees, in equal proportions, for both the 660 nm LEDs and 612 nm LEDs were used. When directed perpendicular to the upper surface of mature cotton plant leaves, it was discovered that a quantum light sensor placed below the leaf registered 10% light transmission for the 30 degree LEDs, and 80% light transmission for the 15 degree LEDs. Using a fully functional prototype described above, it was found that fully 50% of the orange/red spectrum, primarily used for photosynthesis, was transmitted through the upper leaf canopy, making it available to support photosynthesis in leaves below.

These beam angles may vary somewhat depending on the distance of the plants from the lamps. For example, the lamp may be mounted upon the ceiling of a home and directed at a plant on a table. In this case the angles will be reduced from 30/15 degrees but the preferred ratio of beam angles of two to one will remain. Where the lamp is directly mounted upon an aquarium tank having plants therein for example, the beam spread angles could be increased rather than decreased.

At a distance of ten inches from a plant, the distance at which tests were conducted, the lamp of FIGS. 1 and 2 produced a circle of light 10-12 inches in diameter. If a plant is placed below the lamp, only a part of the plant is within the circle of light and the rest of the plant is outside, the portions of the plant outside the light would be expected to grow taller and bend towards the light. As seen in the research, this undesired result did not happen with plants grown under the lamp of the present invention. Instead, the portions of the plant outside the circle of light simply stopped growing but remained healthy. It appears that if a portion of a plant receives sufficient blue light at 470 nm, undesired stem elongation is inhibited for the entire plant. The present invention provides this effect, which can be useful in commercial plant growing applications where plants placed along the periphery of the illumined area may be only partially beneath the light. As long as a plant is at least partially illuminated by one light it will remain healthy without showing the morphology typical of under-illuminated plants (strong phototropism and unwanted stem elongation).

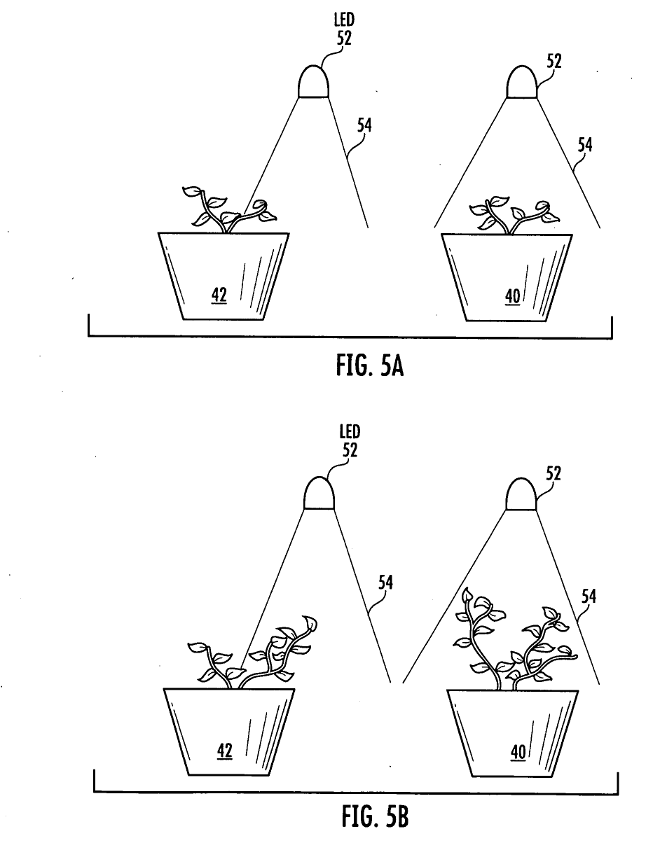

FIG. 5A shows two potted plants growing under the lamp of the present invention to illustrate this effect. At time A, a plant 40, which is completely within the illumination area 54 of the light 52, is the same size as another plant 42 which is only partially within the illumination area 54 of the light 52. In FIG. 5B, at time B, the first plant 40 has grown uniformly, while only the portion of the second plant 42 within the cone of light 54 from light 52 has grown. The portion of the second plant 42 outside the light 54, while unchanged, is still healthy. This effect can be shown over a period of several weeks.

Inventory Control by Adjusting Plant Growth Rate

It is known that the amount of 470 nm blue light reaching a plant affects its morphology, i.e. a low amount of 470 nm light produces longer stem internodes, while a larger amount of 470 nm light produces shorter stem internodes. It is also known that because LED lighting is much cooler than conventional plant lighting sources, an LED-based plant light can be placed much closer to a plant than a conventional plant light, with a resulting increase in light intensity falling on the plant's leaves. It was found that plants tend to grow to within an inch or so of the light, slowing as they approach the lamp (i.e. the stem internode length continues to decrease as the light intensity increases when the plants grow closer to the light source), until they nearly stop growing when within an inch or so of the lights. This is an important feature of the present invention for commercial plant growing operations, where plants which overgrow their pots can't be sold and are typically discarded. Thus, this feature of the present invention would allow a commercial greenhouse to maintain their plants at their optimum size for an extended period simply by lowering the lights to a point near the tops of the plants.

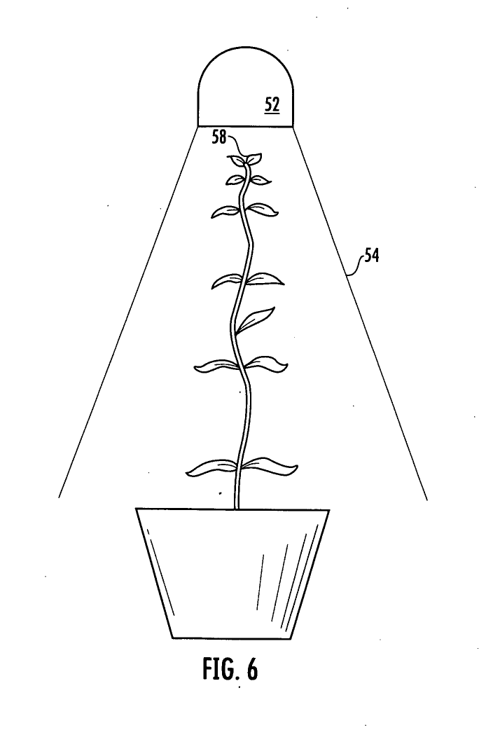

FIG. 6 shows a potted plant 50 growing within the light cone 54 produced by lamp 52. The lower internode 56 is much longer than the internode at the top of the plant 58, which is approximately two inches from our lamp 52. The amount of 470 nm light the plant is receiving at its tip 58 is at least seventy times more intense than what it receives at its base 60. The internodes then become so small the plant's height changes only very slowly over time.

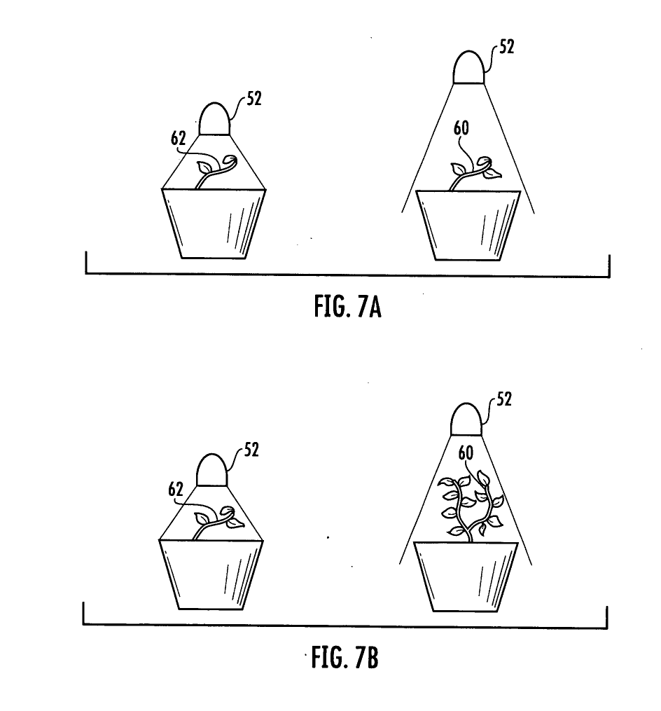

As shown in FIG. 7-A, at time A, the light source 52 over the first plant 62 is lowered close to the plant, while the light source 52 over the second plant 60 is not. As shown in FIG. 7-B, at time B, which may be several weeks later, the first plant 62 shows little change in size, while the second plant 60 has grown considerably during the same time period. The difference is the greatly increased amount of 470 nm blue light reaching the first plant 62, which shortens the internode stem length, thus keeping it short. This feature will allow commercial plant growers to “hold” the size of plants, if necessary, until they can be shipped. Otherwise, they would overgrow their pots and be spoiled. The resulting inventory control is of course of great importance in running a plant growing business.

Thus, during an extended time period of typically several weeks, it is possible to selectively position LED lamps having a substantial amount of blue light at varying distances from growing plants for controlling plant growth rates that vary with said distances. This takes advantage of the property of LEDs to remain cool so that they can be positioned close to the tops of the plants as described above.

Plant Health Indicator Embodiment

Previously, developing an artificial light for growing plants was based upon starting with an existing lamp used for general purpose area lighting and modifying the lamp to improve light output in light spectra that are useful for plant growth and development. The result was a light that served the dual roles of general purpose lighting as well as enhanced plant growing capabilities. These lamps were moderately useful for growing plants, while remaining very good at illuminating a given space and the items within it. The net result was that these same plant growing lamps also presented to the human eye good visual information about the health of the plants grown beneath them.

The development of light emitting diode (LED) technology allowed lamp manufacturers the ability to select specific light frequencies to narrowly target plant growth and development spectra. While this made artificial plant growing lights more efficient because nearly all of the light shining on the plants was absorbed by them, it also eliminated many of the wavelengths that are sensed by the human eye. The light reflected off the plants gave a visual cue to a human to quickly determine the general health of the plants being grown under artificial lights. Under LED lamps targeted to specific light frequency for plants, the plants appear dark grey to a human eye.

A key part of the research of the present invention involved the determination of which light frequencies or wavelengths from a plant light would produce the desired human visual feedback. The determination was based upon light reflection off of plant leaves and growing plants to determine general plant health using light emitting diode devices and designs.

Certain light frequencies when reflected off of a plant can provide an indication of general plant health to a human observer. The light frequencies needed to provide the appropriate visual plant health information are not absorbed by plants, and are typically light frequencies to which the human eye is most sensitive. Thus these light frequencies, when carefully selected, can be added to a light emitting diode plant growing light as a very small proportion of the light being emitted by the lamp, maintaining its overall efficiency while greatly improving the esthetic appearance of the plants grown under them.

Human color vision (photopic) peaks between 500 nanometers and 600 nanometers. This human vision frequency range encompasses the colors from bluish green to green to yellow. The frequency range between 500 nanometers and 600 nanometers is also the least absorbed light frequencies by plants. This fact is evident in the typical green to yellow appearance of plant leaves in a naturally lit environment. The frequency range of 500 to 600 nanometers is therefore the ideal frequency range for reflecting off of plant leaves in order for a human to obtain an indication of general plant health when using light emitting diodes as a plant growing light source.

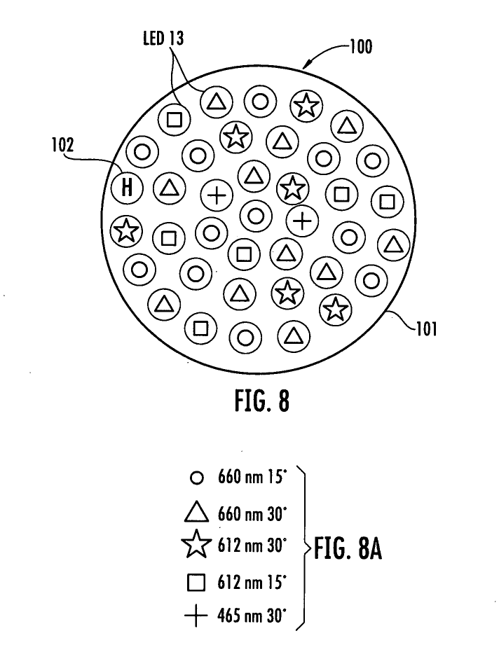

Referring to FIG. 8, a plant growing lamp 100 is shown. Lamp 100 has a lamp housing 101. Plant growing lamp 100 is similar to plant growing lamp 11 except that one of the red 660 nanometer light emitting diodes has been replaced with a green light emitting diode 102 (designated with an H). Light emitting diode 102 can be a light emitting diode that generates light frequencies having a peak wavelength between 500 and 600 nanometers. Light emitting diodes are commercially available in the frequency range of 500 to 600 nanometers.

Light emitting diode 102 would be connected to a power source as previously described for lamp 11. In the example shown in FIG. 8, a light emitting diode generating wavelengths between 500 and 600 nanometers is mounted into an existing light emitting diode grow light to give an indication of plant health. While one light emitting diode 102 was shown mounted in lamp 100, more than one light emitting diode 102 can be mounted in lamp 100.

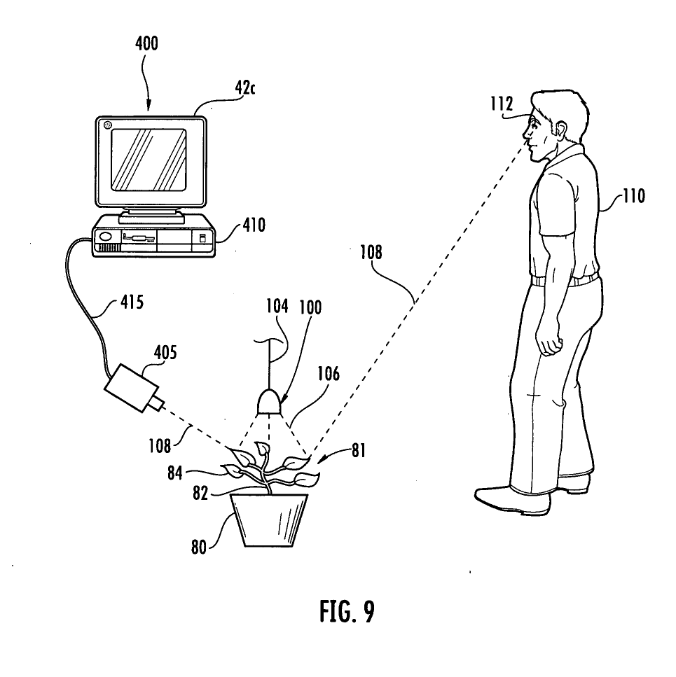

Turning now to FIG. 9, a human observer 110 is shown using lamp 100 of FIG. 8 in order to obtain an indication of general plant health. A container 80 holds a plant 81. Plant 81 has stems 82 and leaves 84. Lamp 100 is mounted above plant 80 and is connected to a power source by an electrical cable 104. Incident light rays 106 are emitted by lamp 100 and impinge upon leaves 84. Light rays 106 contain wavelengths including red 660 nanometers, orange 612 nanometers, blue 465 nanometers and green wavelengths in the range of 500 to 600 nanometers.

Reflected light rays 108 are reflected by leaves 84 and are scattered in multiple directions. Reflected light rays 108 can be scattered such that they are received by the eye 112 of a human observer 110. From the reflected light rays 108, the human observer 110 is readily able to determine the general plant health of plant 81.

With continued reference to FIG. 9, lamp 100 of FIG. 8 is also shown in combination with a computer system 400 for determining general plant health. Computer system 400 includes a sensor or camera 405 and a computer 410 that is connected to sensor 405 by a cable 415. Sensor 405 can be a camera or can be sensor that is sensitive to light in the 500 to 600 nanometer frequency range. Computer 410 can also be connected to sensor 405 through a wireless connection using RF or infrared transmissions. Computer 410 can include a video display 420.

Reflected light rays 108 can be scattered such that they are received by sensor 405 and converted into an electrical signal. The electrical signal is received by computer 410. A human observer can therefore view an image of light rays 108 on a video display 420 and is readily able to determine the general plant health of plant 81. Computer recognition system 400 allows for the observation of plant health to be performed remotely from the plant growing location.

Computer system 400 can also make a determination of general plant health without a human observer. Computer system 400 can be programmed with software that can analyze data received from sensor 405 and make a determination of plant health. The results of the software analysis can be provided as a report to a human. Alternatively, the results of the software analysis can be coupled through computer 410 to control various plant growing variables. For example, computer 410 could be installed in a greenhouse and connected with lighting and watering controls such that the amount of light and water received by plants in the greenhouse is automatically adjusted based upon the software analysis.

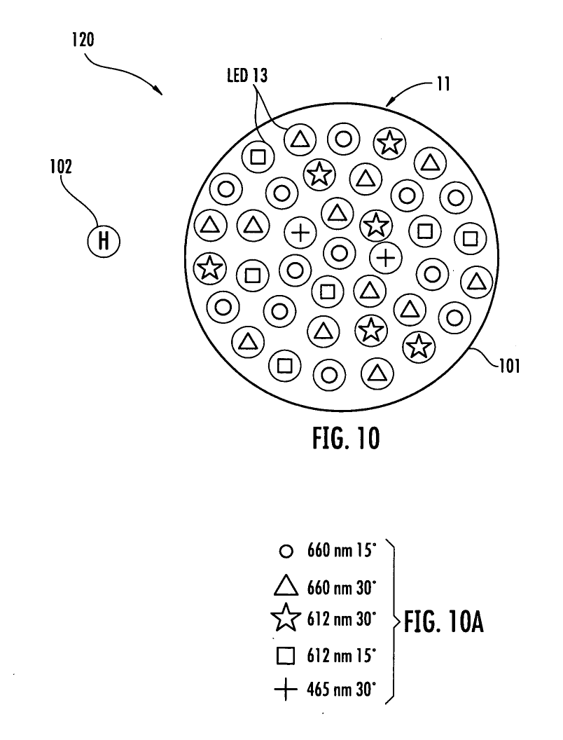

Referring to FIG. 10, another plant growing lamp 120 is shown. Plant growing lamp 120 is similar to plant growing lamp 11 except that green light emitting diode 102 (designated with an H) is mounted separately or external from lamp housing 101. Light emitting diode 102 can be a light emitting diode that generates light frequencies having a peak wavelength between 500 and 600 nanometers. The use of lamp 120 readily allows an LED 102 to be added to existing plant growing lights to give an indication of plant health to a human observer. While one light emitting diode 102 was shown mounted outside housing 101, more than one light emitting diode 102 can be mounted external to housing 101.

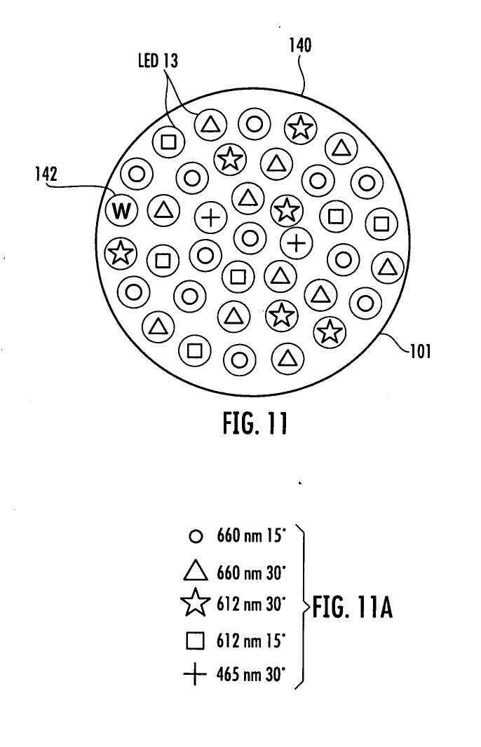

An alternative plant growing lamp 140 is shown in FIG. 11. Plant growing lamp 140 is similar to plant growing lamp 100 except that green light emitting diode 102 has been replaced by a white light emitting diode 142 (designated by W) mounted in lamp housing 101. White light emitting diode 142 generates a wide spectrum of light frequencies that make up white light. White light emitting diodes are commercially available. White light typically consists of all wavelengths between 400 and 700 nanometers in combination. White light includes output frequencies in the 500 to 600 nanometer range. Lamp 140 allows a human to observe an indication of plant health. While one white light emitting diode 142 is shown mounted in lamp 140, more than one white light emitting diode 142 can be mounted in lamp 140.

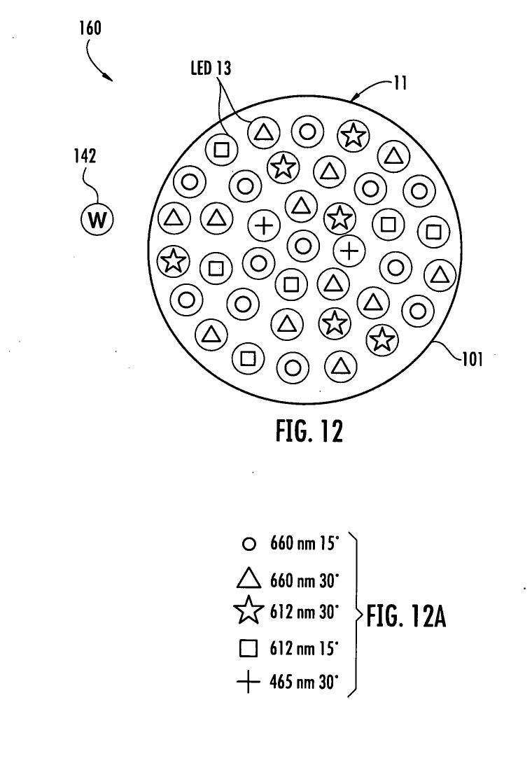

Referring to FIG. 12, another plant growing lamp 160 is shown. Plant growing lamp 160 is similar to plant growing lamp 120 except that green light emitting diode 102 has been replaced by white light emitting diode 142. White light emitting diode 142 is mounted separately or external from lamp housing 101. The use of lamp 160 readily allows an LED 142 to be added to existing plant growing lights to give an indication of plant health to a human observer. While one white light emitting diode 142 was shown mounted outside housing 101, more than one white light emitting diode 142 can be mounted outside housing 101.

Alternative Beam Spread Angle Embodiments

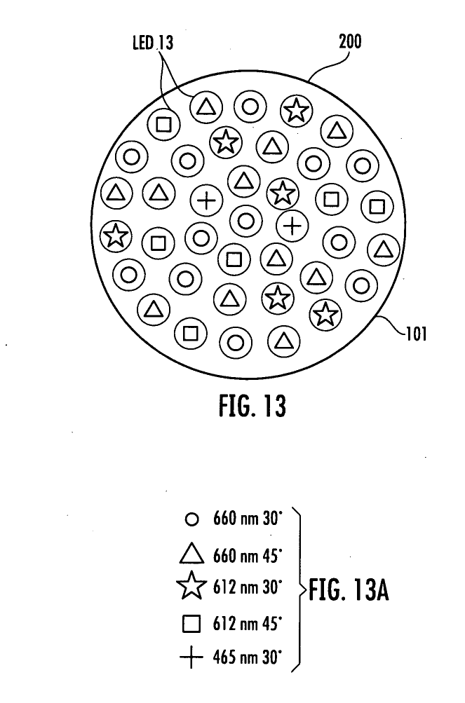

Turning to FIGS. 13 and 13a, another plant growth lamp 200 is shown. Plant growth lamp 200 has an array of LEDs with varying beam spread angles. More specifically, lamp 200 has beam spreads of 30 degrees and 45 degrees, in equal proportions, for both the 660 nm LEDs and 612 nm LEDs. FIG. 13 schematically indicates a typical spatial distribution of the LEDs and FIG. 13a indicates the peak wavelengths and beam angles.

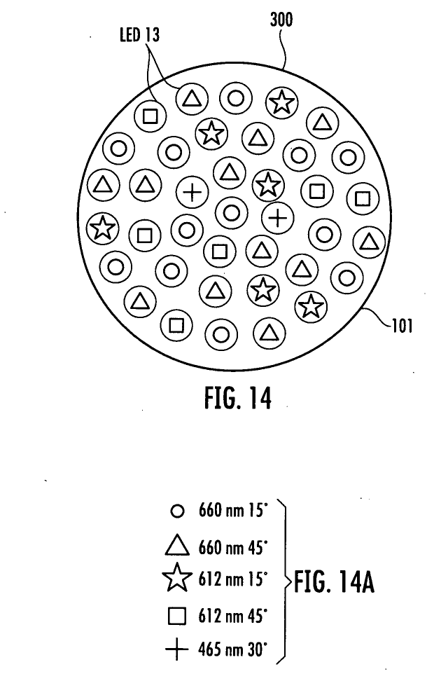

Turning to FIGS. 14 and 14a, another plant growth lamp 300 is shown. Plant growth lamp 300 has an array of LEDs with varying beam spread angles. More specifically, lamp 300 has beam spreads of 15 degrees and 45 degrees, in equal proportions, for both the 660 nm LEDs and 612 nm LEDs. The 465 nm LEDs have a beam spread of 30 degrees. FIG. 14 schematically indicates a typical spatial distribution of the LEDs and FIG. 14a indicates the peak wavelengths and beam angles.

While beam spread angle pairs of 15 to 45 degrees were illustrated, it is to be appreciated that other beam spread angle combinations can be used in the plant growth lamp of the present invention. For example, the following beam spread pair for the LEDs can be used:

1. 660 nm (30 degree and 8 degree) and 612 nm (30 degree and 8 degree).

2. 660 nm (15 degree and 8 degree) and 612 nm (15 degree and 8 degree).

3. 660 nm (all 30 degree) and 612 nm (all 30 degree).

3. 660 nm (all 45 degree) and 612 nm (all 45 degree).

While beam spread angle pairs of 8 to 45 degrees were illustrated, it is to be further appreciated that any beam spread combination either alone or in combination between 5 and 120 degrees can be used in the plant growth lamp of the present invention.

Effect of Green Light on Plant Growth

Green light, including wavelengths from 500 nm-600 nm (yellow to green), is suitable for conveying information to a plant about its environment. For example, plants in the understory (i.e. growing below other plants) receive light which is depleted of red and blue (absorbed by the overhanging canopy), but which has a high level of far-red and green light (transmitted through the overhanging canopy). Leaves grown under RedGreenBlue have larger surface area and less thickness compared to leaves grown under RedBlue alone. In addition, seeds illuminated with high levels of green light produce plants with increased biomass. Root crops such as radish and carrots are twice as large as those grown from seeds not illuminated with green light.

### CONCLUSION

Although the description above contains many specifications, these should not be construed as limiting the scope of the invention but as merely providing illustrations of some of presently preferred embodiments of this invention. Thus, the scope of the invention should be determined by the issued claims and their legal equivalents rather than by the examples given.

What is claimed is:

1. A method of determining plant health comprising the steps of:
(A) providing an LED lamp emitting green light having a wavelength between 500 and 600 nanometers;
(B) illuminating at least one plant with incident light generated by the LED lamp; and
(C) allowing an observer to view the light reflected from the plant, the reflected light giving an indication of plant health to the observer.

2. The method of claim 1 wherein the LED lamp emitting green light further emits orange light having a peak wavelength emission of about 612 nanometers, red light having a peak wavelength of about 660 nanometers and blue light having a peak wavelength of about 465 nanometers.

3. A method for growing a plant comprising:
(A) providing a plant lamp comprising:
(a) a lamp housing;
(b) a first number of orange light emitting diodes mounted in the housing and having a peak wavelength of about 612 nanometers;
(c) a second number of red light emitting diodes mounted in the housing and having a peak wavelength of about 660 nanometers; and
(d) a third number of light emitting diodes mounted in the housing and having a peak wavelength between 500 and 600 nanometers, wherein the red and orange light emitting diodes in combination output light that stimulates plant growth and the third number of light emitting diodes provide an observer with an indication of plant health;
(e) wherein the third number is less than the first number and less than the second number; and
(B) illuminating a plant with the plant lamp.

4. The method of claim 3 further comprising determining the health of the plant.

5. The method of claim 4 wherein determining the health of the plant comprises observing light from the third number of light emitting diodes that is reflected by the plant.

6. The method of claim 4 wherein determining the health of the plant comprises:
(A) providing a sensor comprising a peak wavelength responsiveness between 500 nanometers and 600 nanometers; and
(B) sensing light reflected from the plant using the sensor.

7. The method of claim 6 wherein sensing light reflected from the plant comprises sensing light from the third number of light emitting diodes that is reflected by the plant.

8. The method of claim 6 further comprising:
(A) providing a computer;
(B) communicating a signal from the sensor to the computer.

9. The method of claim 8 further comprising:
(A) generating an image on the computer from the signal; and
(B) displaying the image on a video display of the computer.

10. The method of claim 8 further comprising using the computer to control at least one plant growing variable dependent on the signal.

11. The method of claim 10 wherein the at least one plant growing variable comprises at least one lighting control.

12. The method of claim 10 wherein the at least one plant growing variable comprises at least one watering control.

13. The method of claim 3 wherein the third number is less than 3% of the first number and second number combined.

14. The method of claim 3 wherein the third number of light emitting diodes comprises at least one green light emitting diode.

15. The method of claim 3 wherein the third number of light emitting diodes comprises at least one white light emitting diode.

16. The method of claim 3 wherein the lamp further comprises a fourth number of blue light emitting diodes that have a peak wavelength of about 465 nanometers.

17. A method for growing a plant comprising:
(A) providing a plant;
(B) providing a lamp; and
(C) illuminating the plant with the lamp;
(D) wherein the lamp comprises:
(a) orange light generating means for generating orange light having a wavelength of about 612 nanometers;
(b) red light generating means for generating red light having a wavelength of about 660 nanometers; and
(c) green light generating means for generating green light having a wavelength between 500 to 600 nanometers;
(d) wherein an amount of said green light generating means is less than 3% of a combined amount of said orange and red light generating means.

18. The method of claim 17 comprising illuminating the plant with the orange light generating means and red light generating means to stimulate plant growth.

19. The method of claim 17 comprising illuminating the plant with the green light generating means to determine an indicator of plant health.

20. The method of claim 19 further comprising:
(A) providing a sensor responsive to light produced by said green light generating means; and
(B) sensing light reflected from the plant using the sensor.

21. The method of claim 17 wherein the green light generating means comprises at least one green light emitting diode.

22. The method of claim 17 wherein the green light generating means comprises at least one white light emitting diode.
